(19) United States
(12) Patent Application Publication
(10) Pub. No.: US 2025/0055952 A1
(43) Pub. Date: Feb. 13, 2025

(54) FUNCTION EXECUTING DEVICE, SERVER, AND NON-TRANSITORY COMPUTER-READABLE RECORDING MEDIUM STORING COMPUTER-READABLE INSTRUCTIONS FOR FUNCTION EXECUTING DEVICE

(71) Applicant: BROTHER KOGYO KABUSHIKI KAISHA, Nagoya (JP)

(72) Inventor: Takanori SAITO, Nagoya (JP)

(21) Appl. No.: 18/795,696

(22) Filed: Aug. 6, 2024

(30) Foreign Application Priority Data
Aug. 7, 2023 (JP) 2023-128852

(51) Int. Cl. H04N 1/00

(52) U.S. Cl. CPC H04N 1/0097; H04N 1/00244; H04N 2201/0094

(57) ABSTRACT

A function executing device may include a memory storing a plurality of setting information corresponding to a plurality of setting items; and a controller. The controller may be configured to: acquire environmental information related to an installation environment of the function executing device; determine whether the installation environment of the function executing device has changed by using the environmental information; in a case where it is determined that the installation environment of the function executing device has changed, send change information to a server; in a case where the change information is sent to the server and a deletion request is provided to the server from a user of the function executing device, receive a deletion instruction from the server; and in a case where the deletion instruction is received from the server, delete at least one setting information of the plurality of setting information from the memory.

### REFERENCE TO RELATED APPLICATION

This application claims priority to Japanese Patent Application No. 2023-128852 filed on Aug. 7, 2023. The entire content of the priority application is incorporated herein by reference.

### BACKGROUND ART

A computer is known that determines whether a user has authorization to use it or not by making the user input a password when the usage environment is different from usual.

### SUMMARY

The disclosure herein provides a novel technology for deleting setting information of a function executing device.

Disclosed herein is a function executing device. The function executing device may comprise a memory configured to store a plurality of setting information corresponding to a plurality of setting items; and a controller. The controller may be configured to: acquire environmental information related to an installation environment of the function executing device; determine whether the installation environment of the function executing device has changed by using the environmental information; in a case where it is determined that the installation environment of the function executing device has changed, send change information to a server; in a case where the change information is sent to the server and a deletion request is provided to the server from a user of the function executing device, receive a deletion instruction from the server; and in a case where the deletion instruction is received from the server, delete at least one setting information of the plurality of setting information from the memory.

According to the configuration above, the function executing device sends the change information to the server in the case where it is determined based on the environmental information that the installation environment of the function executing device has changed. The function executing device then receives the deletion instruction from the server in the case where the deletion request is provided to the server from the user of the function executing device, and can delete at least one setting information. Thus, the novel technology for deleting setting information of the function executing device is provided.

Also disclosed herein is a server. The server may comprise a controller. The controller may be configured to: in a case where an installation environment of a function executing device changes, receive change information from the function executing device, wherein the function executing device is configured to store a plurality of setting information corresponding to a plurality of setting items; and in a case where the change information is received from the function executing device and a deletion request is acquired from a user of the function executing device, send a deletion instruction to the function executing device, wherein the deletion instruction is an instruction to delete at least one setting information of the plurality of setting information.

According to the configuration above, the server receives the change information from the function executing device in the case where the installation environment of the function executing device has changed. The server then sends the deletion instruction to the function executing device in the case where it acquires the deletion request from the user of the function executing device. At least one setting information is thereby deleted in the function executing device. Thus, the novel technology for deleting setting information of the function executing device is provided.

Computer-readable instructions for implementing the above function executing device, a non-transitory computer-readable storage medium storing the computer-readable instructions, and a method performed by the function executing device are also novel and useful. Computer-readable instructions for implementing the above server, a non-transitory computer-readable storage medium storing the computer-readable instructions, and a method performed by the server are also novel and useful. A communication system comprising the function executing device and the server as described above is also novel and useful.

### BRIEF DESCRIPTION OF DRAWINGS

FIG. 1 shows a configuration of a communication system.

FIG. 2 shows a flowchart of a search process.

FIG. 3 shows a sequence diagram for Case A according to a first embodiment.

FIG. 4 shows a sequence diagram for Case B.

FIG. 5 shows a sequence diagram for Case C.

FIG. 6 shows a sequence diagram according to a second embodiment.

### DESCRIPTION

### First Embodiment

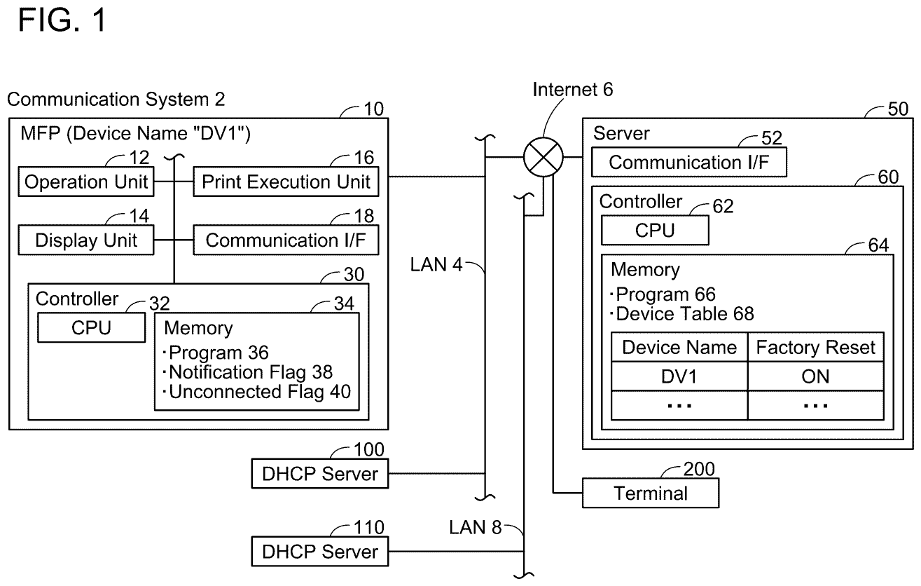

### Configuration of Communication System 2: FIG. 1

As shown in FIG. 1, a communication system 2 comprises an MFP (multifunction peripheral) 10, a server 50, a plurality of DHCP (dynamic host configuration protocol) servers 100, 110, and a terminal 200. The MFP 10 and the DHCP server 100 are connected to a LAN (local area network) 4 and can communicate with each other via the LAN 4. The DHCP server 110 is connected to a LAN 8. Each of the LANs 4, 8 may be a wired LAN or a wireless LAN. The LANs 4, 8 are connected to the internet 6. The server 50 is installed on the internet 6. The MFP 10 can communicate with the server 50 via the internet 6. The terminal 200 is connected to a LAN (not shown). The terminal 200 can communicate with the server 50 via the internet 6.

### Configuration of MFP 10

The MFP 10 is a peripheral device (e.g., a peripheral device of a terminal device which is not shown) configured to execute a print function, a scan function, a copy function, a FAX function, etc. A device name “DV1” for identifying the MFP 10 is assigned to the MFP 10. The MFP 10 comprises an operation unit 12, a display unit 14, a print execution unit 16, a communication interface 18, and a controller 30. Hereinafter, an interface is abbreviated as “I/F”.

The operation unit 12 comprises a plurality of keys. A user can input various instructions to the MFP 10 by operating the operation unit 12. The display unit 14 is a display for displaying various information. The display unit 14 may function as a touch screen (i.e., the operation unit 12).

The print execution unit 16 comprises a print mechanism of inkjet scheme, laser scheme, or the like. The communication I/F 18 is connected to the LAN 4. The communication I/F 18 may be a wireless I/F or a wired I/F.

The controller 30 comprises a CPU 32 and a memory 34. The memory 34 includes a main storage and an auxiliary storage, which are not shown. The CPU 32 executes various processes according to a program 36 stored in the auxiliary storage of the memory 34. Specifically, the CPU 32 loads the program 36 from the auxiliary storage to the main storage to execute the program 36, thereby executing various processes. The main storage comprises for example a RAM and a cache memory. The auxiliary storage may comprise for example a flash memory, an SSD (solid state drive), or a ROM, or a combination thereof. The memory 34 further stores a notification flag 38 and an unconnectable flag 40.

### Configuration of Server 50

The server 50 is installed on the internet 6 by the vendor of the MFP 10. In a modification, the server 50 may be installed on the internet 6 by a business operator different from the vendor. In another modification, the vendor of the MFP 10 may use an environment provided by an external cloud computing service without preparing hardware for the server 50 by itself. In this case, the vendor may implement the server 50 by preparing a program (i.e., software) for the server 50 and introducing it to the above environment.

The server 50 comprises a communication I/F 52 and a controller 60. The communication I/F 52 is connected to the internet 6. The controller 60 comprises a CPU 62 and a memory 64. The memory 64 comprises a main storage and an auxiliary storage. The main storage comprises a RAM and a cache memory, although this is merely an example. The auxiliary storage may comprise a ROM, a flash memory, an SSD (solid state drive), an HDD (hard disk drive), or a combination thereof, although this is merely an example. A program 66 is stored in the auxiliary storage of the memory 64. The CPU 62 executes various processes according to the program loaded from the auxiliary storage to the main storage.

A device table 68 is also stored in the auxiliary storage of the memory 64. In the device table 68, device names (e.g., “DV1”) and factory reset flags are stored in association with each other. Each factory reset flag indicates either: “ON” indicating that a factory reset is permitted to be executed or “OFF” indicating that the factory reset is prohibited from being executed. The factory reset means a process of deleting information (e.g., setting information) in the MFP 10 to reset the internal state of the MFP 10 to that of the MFP 10 at the time of shipment.

### Configurations of DHCP Servers 100, 110

The DHCP server 100 is configured to assign IP addresses to respective devices within the LAN 4. In response to receiving an IP address assignment request from a device within the LAN 4, the DHCP server 100 selects a single IP address from among predetermined IP addresses and sends the selected IP address and a predetermined subnet mask to the device. The DHCP server 110 is configured to assign IP addresses to respective devices within the LAN 8.

### Configuration of Terminal 200

The terminal 200 is an administrator terminal used by the administrator of the MFP 10. The terminal 200 is a portable terminal device such as a mobile phone, a smartphone, a PDA, a laptop PC, a tablet PC, or the like. In a modification, the terminal 200 may be a stationary terminal device such as a desktop PC or the like.

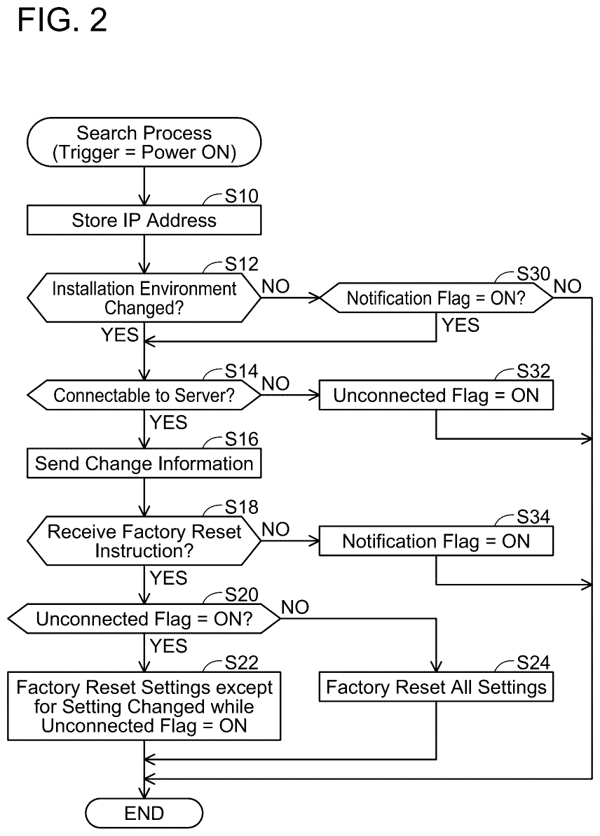

### Search Process by MFP: FIG. 2

Referring to FIG. 2, a search process executed by the CPU 32 of the MFP 10 is described. The search process shown in FIG. 2 is started in response to the MFP 10 being turned on.

In S10, the CPU 32 receives an IP address and a subnet mask assigned by the DHCP server 100 via the communication I/F 18 and stores them in the memory 34.

In S12, the CPU 32 first specifies a network address of the LAN 4 to which the MFP 10 currently belongs, based on the stored IP address and subnet mask. The CPU 32 then compares the network address specified in S12 of the ongoing search process with the network address specified in S12 of the previous search process to determine whether the network to which the MFP 10 belongs (i.e., installation environment of the MFP 10) has changed or not. When determining that the network has changed, the CPU 32 determines YES in S12 and proceeds to S14, whereas when determining that the network has not changed, the CPU 32 determines NO in S12 and proceeds to S30.

In S30, the CPU 32 determines whether the notification flag 38 in the memory 34 indicates “ON”. Details of the notification flag 38 will be described later. When the notification flag 38 indicates “ON”, the CPU 32 determines YES in S30 and proceeds to S14, whereas when the notification flag 38 indicates “OFF”, the CPU 32 determines NO in S30 and terminates the process of FIG. 2.

In S14, the CPU 32 determines whether the CPU 32 is connectable to the server 50. For example, the CPU 32 sends a predetermined connection signal to the server 50, and when receiving a response signal from the server 50, the CPU 32 determines that it is connectable to the server 50. When connectable to the server 50, the CPU 32 determines YES in S14 and proceeds to S16, whereas when unconnectable to the server 50, the CPU 32 determines NO in S14 and proceeds to S32.

In S32, the CPU 32 changes the unconnectable flag 40 in the memory 34 from “OFF” to “ON”. The unconnectable flag 40 indicates either: “ON” indicating that the CPU 32 is unconnectable to the server 50 or “OFF” indicating that the CPU 32 is connectable to the server 50. In other words, the unconnectable flag 40 indicates either: “ON” indicating that non-deletion setting information is to be stored or “OFF” indicating that non-deletion setting information is not to be stored, which will be described in detail later. The non-deletion setting information is setting information that is not deleted in the factory reset. When S32 is completed, the CPU 32 terminates the process of FIG. 2.

In S16, the CPU 32 sends change information to the server 50 via the communication I/F 18. The change information indicates that the installation environment of the MFP 10 has changed.

In S18, the CPU 32 determines whether a factory reset instruction has been received from the server 50. In response to receiving a factory reset request from the user, the server 50 sends a factory reset instruction to the MFP 10. When determining that the factory reset instruction has been received from the server 50, the CPU 32 determines YES in S18 and proceeds to S20, whereas when determining that the factory reset instruction has not been received from the server 50, the CPU 32 determines NO in S18 and proceeds to S34.

In S34, the CPU 32 changes the notification flag 38 in the memory 34 from “OFF” to “ON”. The notification flag 38 indicates either: “ON” indicating that when the process of FIG. 2 is executed next time, the change information is to be sent to the server 50 even though the network to which the MFP 10 belongs does not change (YES in S30) or “OFF” indicating that the change information is not to be sent to the server 50 if the network to which the MFP 10 belongs does not change (NO in S30). When S34 is completed, the CPU 32 terminates the process of FIG. 2.

In S20, the CPU 32 determines whether the unconnectable flag 40 in the memory 34 indicates “ON”. When the unconnectable flag 40 indicates “ON”, the CPU 32 determines YES in S20 and proceeds to S22, whereas when the unconnectable flag 40 indicates “OFF”, the CPU 32 determines NO in S20 and proceeds to S24.

In S22, the CPU 32 executes the factory reset to setting information except for setting information that corresponds to setting items that have been changed while the unconnectable flag 40 indicates “ON”. Specifically, for example, when the user changes setting information corresponding to a setting item “print setting” of the MFP 10 while the unconnectable flag 40 indicates “ON”, the CPU 32 stores non-deletion setting information that includes item information indicating the print setting and the changed setting information. Thereafter, in the factory reset, the CPU 32 deletes setting information except for that non-deletion setting information from the memory 34. When S22 is completed, the CPU 32 terminates the process of FIG. 2.

In S24, the CPU 32 executes the factory reset to all setting information. Specifically, the CPU 32 deletes all setting information corresponding to all setting items from the memory 34. When S24 is completed, the CPU 32 terminates the process of FIG. 2. Here, “all setting items” include for example a print setting, a scan setting, a communication setting, an address book, etc.

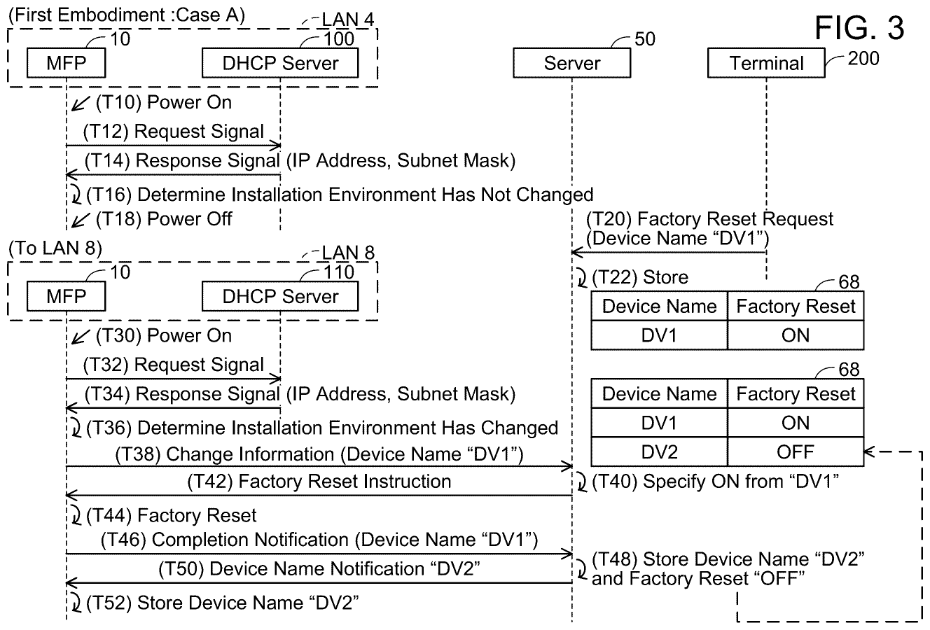

### Specific Cases: FIGS. 3 to 5

Referring to FIGS. 3 to 5, specific Cases A to C which can be realized by the process of FIG. 2 are described. In Cases A to C, the installation environment of the MFP 10 changes from the LAN 4 to the LAN 8 in response to a user of the MFP 10 changing to another user. The former user of the MFP 10 causes the MFP 10 to execute the factory reset. Due to the factory reset executed in the MFP 10, the new user is unable to know setting information in the MFP 10 set by the former user. That is, from a perspective of the former user, setting information that he/she set is prevented from being known by others. From a perspective of the new user, he/she can start using the MFP 10 as if it was fresh out of a factory since the setting information set by others has been deleted. For example, if the former user has set the MFP 10 to send a received fax to a predetermined e-mail address, information related to this setting can be deleted from the MFP 10 by the factory reset.

Examples of a user of the MFP 10 changing to another user include that a parent gives the MFP 10 to his/her child when the child moves out of the parent's home for work or marriage, that a department gives the MFP 10 to another department (e.g., another branch) within a company, etc.

When the MFP 10 connects to the server 50 for the first time, the MFP 10 receives from the server 50 the device name “DV1” of the MFP 10 created by the server 50 and stores the device name “DV1” in the memory 34. The server 50 stores the device name “DV1” and the factory reset flag “OFF” in association with each other in the device table 68.

### Case A: FIG. 3

Hereinafter, for easier understanding, actions executed by the CPUs of the devices (e.g., the CPU 32 of the MFP 10) are described with the devices themselves (e.g., the MFP 10), not their CPUs, as the subjects of the actions. In Case A shown in FIG. 3, the administrator who is the former user of the MFP 10 requests the factory reset to the server 50 before the server 50 sends a factory reset instruction to the MFP 10.

In the initial state of Case A, the MFP 10 has not been given to a new user yet and is still used by the former user (i.e., the administrator). The former user turns on the MFP 10 in T10 (trigger for the process of FIG. 2). In response, the MFP 10 sends a request signal that requests assignment of an IP address to the DHCP server 100 in T12.

In response to receiving the request signal from the MFP 10 in T12, the DHCP server 100 sends a response signal including an IP address and a subnet mask to the MFP 10 in T14.

In response to receiving the response signal from the DHCP server 100 in T14, the MFP 10 first stores the IP address and the subnet mask included in the received response signal in T16 (S10). The MFP 10 then specifies the network address, compares the specified network address with the stored network address, and determines that the network to which the MFP 10 belongs (i.e., the LAN 4) has not changed (NO in S12). After this, the former user causes the MFP 10 to execute its print function, scan function, etc. (not shown) and then turns off the MFP 10 in T18.

Thereafter, before giving the MFP 10 to the new user, the former user uses the terminal 200 to perform an operation to cause the MFP 10 to execute the factory reset. Specifically, the former user accesses the server 50 using the terminal 200 and performs operations required for the factory reset (e.g., an operation of inputting the device name “DV1” of the MFP 10, an operation of approving the factory reset, etc.). In response, the terminal 200 sends a factory reset request including the device name “DV1” of the MFP 10 to the server 50 in T20.

In response to receiving the factory reset request from the terminal 200 in T20, the server 50 changes the factory reset flag associated with the device ID “DV1” included in the received factory reset request from “OFF” to “ON” in T22.

After that, the MFP 10 is given from the former user to the new user. As a result, the MFP 10 is connected to the LAN 8 which is a network of the new user. In T30, the new user turns on the MFP 10 (trigger for the process of FIG. 2). The MFP 10 sends a request signal that requests assignment of an IP address to the DHCP server 110 in T32.

In response to receiving the request signal from the MFP 10 in T32, the DHCP server 110 sends a response signal including an IP address and a subnet mask to the MFP 10 in T34.

In response to receiving the response signal from the DHCP server 110 in T34, the MFP 10 first stores the IP address and the subnet mask included in the received response signal in T36 (S10). The MFP 10 then specifies the network address, compares the specified network address (i.e., the network address of the LAN 8) with the network address stored in T16 (i.e., the network address of the LAN 4), and determines that the network to which the MFP 10 belongs has changed (YES in S12). In this case, the MFP 10 sends change information including the device name “DV1” to the server 50 in T38 (S16).

In response to receiving the change information from the MFP 10 in T38, the server 50 specifies in T40 that the factory reset flag associated with the device name “DV1” included in the received change information indicates “ON” in the device table 68. In response, the server 50 sends a factory reset instruction to the MFP 10 in T42. When the server 50 specifies that the factory reset flag indicates “OFF”, the server 50 does not send the factory reset instruction to the MFP 10.

In response to receiving the factory reset instruction from the server 50 in T42, the MFP 10 executes the factory reset to delete all setting information in the memory 34 in T44 (YES in S18, S24).

In T46, the MFP 10 sends the server 50 a completion notification indicating that the factory reset has been completed. The completion notification includes the device name “DV1”.

As described, in Case A, when the MFP 10 determines that the installation environment of the MFP 10 has changed based on the network address of the network to which the MFP 10 belongs, the MFP 10 sends the change information to the server 50 (T38 in FIG. 3). In the present case, the factory reset request is sent from the terminal 200 to the server 50 (T20) before the factory reset instruction is sent from the server 50 to the MFP 10. The MFP 10 receives the factory reset instruction from the server 50 in response to having sent the change information to the server 50 after the factory reset request has been provided to the server 50, and deletes all setting information from the memory 34 (T44). Thus, the former user can cause the MFP 10 to execute the factory reset immediately after the new user starts using the MFP 10.

In response to receiving the completion notification from the MFP 10 in T46, the server 50 registers a new device name “DV2” and a factory reset flag “OFF” in the device table 68 in T48. The server 50 then sends a device name notification including the device name “DV2” to the MFP 10 in T50.

In response to receiving the device name notification from the server 50 in T50, the MFP 10 stores the device name “DV2” in the memory 34 in replacement of the stored device name “DV1” in T52.

As described, in response to receiving the completion notification from the MFP 10 in T46, the server 50 creates the new device name “DV2” and stores the device name “DV2” and the factory reset flag “OFF” in association with each other in T48. In response to receiving the device name notification including the new device name “DV2” from the server 50 in T50, the MFP 10 newly stores the device name “DV2” in T52. After this, for example, it can be contemplated that the MFP 10 is connected to a network different from the LAN 8 without the new user giving the MFP 10 to another user, and change information including the device name “DV2” is sent to the server 50. In this situation, the server 50 does not send a factory reset instruction to the MFP 10 since the factory reset flag “OFF” is associated with the device name “DV2” in the device table 68 in the sever 50. Thus, the factory reset is not executed in the MFP 10. Thus, it is possible to prevent the factory reset from being executed in the MFP 10 if the user (i.e., owner) of the MFP 10 does not change, even though the installation environment of the MFP 10 has changed.

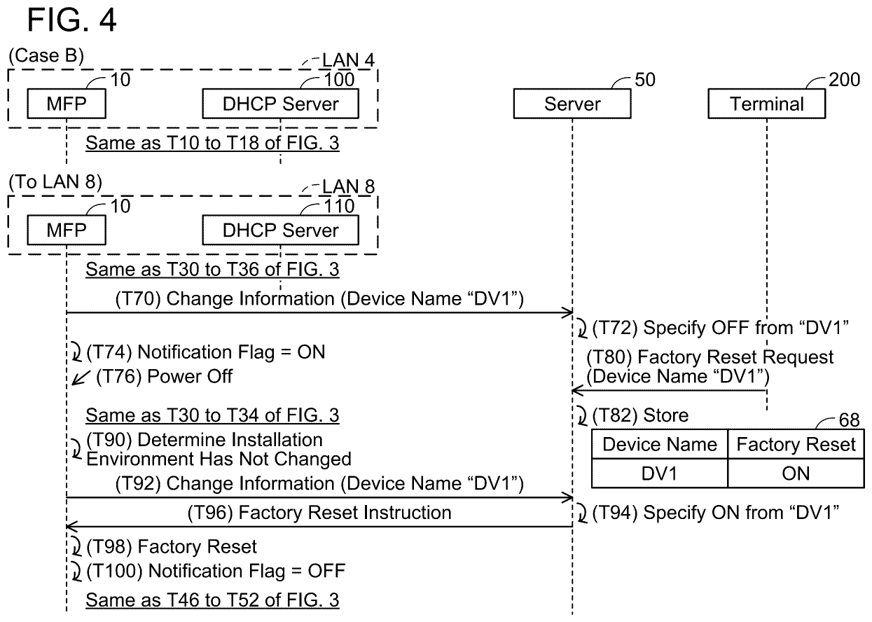

### Case B: FIG. 4

In Case B shown in FIG. 4, the administrator who is the former user requests the factory reset to the server 50 after the MFP 10 has been given to the new user and the new user has started using the MFP 10. The same sequence as T10 to T18 in FIG. 3 is executed between the MFP 10 and the DHCP server 100. Then, the former user gives the MFP 10 to the new user without performing the operations to cause the MFP 10 to execute the factory reset. The MFP 10 then is connected to the LAN 8 which is the network of the new user. After this, the same sequence as T30 to T36 in FIG. 3 is executed.

In T70, the MFP 10 sends change information including the device name “DV1” to the server 50 (S16).

In response to receiving the change information from the MFP 10 in T70, the server 50 specifies in T72 that the factory reset flag associated with the device name “DV1” included in the received change information indicates “OFF” in the device table 68. In this case, the server 50 does not send a factory reset instruction to the MFP 10.

When a predetermined time period has elapsed from the time when the change information was sent to the server 50 in T70 without the MFP 10 receiving a factory reset instruction from the server 50, the MFP 10 changes the notification flag 38 from “OFF” to “ON” in T74 (NO in S18, S34). After this, the new user causes the MFP 10 to execute its print function, scan function, etc., (not shown) and then turns off the MFP 10 in T76.

Thereafter, the former user performs the operations to cause the MFP 10 to execute the factory reset using the terminal 200. In response, the terminal 200 sends a factory reset request including the device name “DV1” of the MFP 10 to the server 50 in T80.

In response to receiving the factory reset request from the terminal 200 in T80, the server 50 changes the factory reset flag associated with the device name “DV1” included in the received factory reset request from “OFF” to “ON” in T82.

Thereafter, when the new user turns on the MFP 10 to use it again, the same sequence as T30 to T34 in FIG. 3 is executed between the MFP 10 and the DHCP server 110. In T90, the MFP 10 compares the specified network address (i.e., the network address of the LAN 8) with the stored network address (i.e., the network address of the LAN 8) and determines that the network to which the MFP 10 belongs has not changed (NO in S12).

In T92, the MFP 10 first specifies that the notification flag 38 indicates “ON” and then sends change information including the device name “DV1” to the server 50 (YES in S30, S16). A sequence from T94 to T98 is the same as the sequence from T40 to T44 in FIG. 3. That is, the MFP 10 receives a factory reset instruction from the server 50 in T96 and then executes the factory reset in T98. The MFP 10 then changes the notification flag 38 from “ON” to “OFF” in T100. After this, the same sequence as T46 to T52 in FIG. 3 is executed.

As described, in Case B, the MFP 10 sends the change information to the server 50 (T70) under the state where the device name “DV1” is associated with the factory reset flag “OFF” in the device table 68 in the server 50. In this case, the server 50 does not send a factory reset instruction to the MFP 10. In response to the former user performing the operations to cause the MFP 10 to execute the factory reset using the terminal 200, the factory reset request is sent from the terminal 200 to the server 50 (T80). In response, the server 50 changes the factory reset flag associated with the device name “DV1” from “OFF” to “ON” (T82).

Further, when the predetermined time period has elapsed from the time when the change information was sent to the server 50 in T70, the MFP 10 changes the notification flag 38 from “OFF” to “ON” in T74. This allows the MFP 10 to send change information to the server 50 when the MFP 10 is turned on next time even though the network to which the MFP 10 belongs has not changed (T92). Thus, the MFP 10 can receive a factory reset instruction from the server 50 (T96). As above, the former user can cause the MFP 10 to execute the factory reset via the server 50 even after the new user started using the MFP 10, i.e., even when the former user no longer owns the MFP 10.

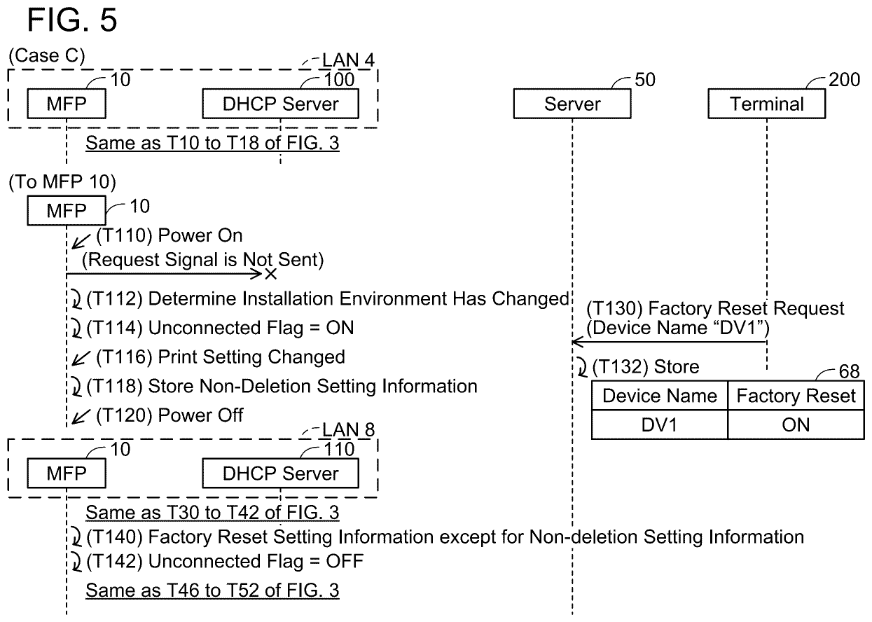

### Case C: FIG. 5

In Case C shown in FIG. 5, setting information of the MFP 10 is changed by the new user after the MFP 10 has been given to the new user and before the MFP 10 is connected to the LAN 8 which is the network of the new user.

The same sequence as T10 to T18 in FIG. 3 is executed between the MFP 10 and the DHCP server 100. After this, the former user gives the MFP 10 to the new user without performing the operations to cause the MFP 10 to execute the factory reset.

In T110, the new user turns on the MFP 10 without connecting the MFP 10 to the LAN 8. The MFP 10 cannot send a request signal to the DHCP server since it is not connected to a network. Since the MFP 10 cannot receive a network address from the DHCP server that matches the stored network address (i.e., the network address of the LAN 4), the MFP 10 determines in T112 that the network to which the MFP 10 belongs (i.e., installation environment) has changed (YES in S12 of FIG. 2). Then the MFP 10 determines that it is unconnectable to the server 50 and changes the unconnectable flag 40 from “OFF” to “ON” (NO in S14, S32).

In T116, the new user changes setting information for print setting in the MFP 10. In response, the MFP 10 stores non-deletion setting information including item information indicating the print setting and the changed setting information in the memory 34 in T118. Then, the new user turns off the MFP 10 in T120.

Meanwhile, the former user performs the operations to cause the MFP 10 to execute the factory reset using the terminal 200 in T130. In response, the terminal 200 sends a factory reset request including the device name “DV1” of the MFP 10 to the server 50 in T130.

In response to receiving the factory reset request from the terminal 200 in T130, the server 50 changes the factory reset flag associated with the device name “DV1” included in the received factory reset request from “OFF” to “ON” in T132.

Thereafter, the MFP 10 is connected to the LAN 8 which is the network of the new user. Then, the same sequence as T30 to T42 in FIG. 3 is executed. In response to receiving a factory reset instruction from the server 50 in T42, the MFP 10 executes the factory reset in T140, so that the stored non-deletion setting information is not deleted from the memory 34 but the other setting information is deleted from the memory 34. The MFP 10 then changes the unconnectable flag 40 from “ON” to “OFF” in T142. Thereafter, the same sequence as T46 to T52 in FIG. 3 is executed.

In Case C, when the MFP 10 determines that the installation environment of the MFP 10 has changed based on the network address of the network to which it belongs (T112) and determines that the MFP 10 is unconnectable to the server 50, the MFP 10 changes the unconnectable flag 40 from “OFF” to “ON” (T114). When the print setting is changed by the new user after the unconnectable flag 40 has changed from “OFF” to “ON” and before the MFP 10 receives the factory reset instruction from the server 50, the MFP 10 stores the non-deletion setting information in the memory 34 (T118). Thereafter, when the MFP 10 is connected to the LAN 8 and then receives the factory reset instruction from the server 50, the MFP 10 executes the factory reset to delete the setting information except for the non-deletion setting information from the memory 34 (T140).

As described, the MFP 10 stores non-deletion setting information (T118) when the new user sets setting information of the MFP 10 after the MFP 10 has been given to the new user. The MFP 10 then executes the factory reset to delete the setting information except for the non-deletion setting information from the memory 34 (T140). Therefore, the new user can use the print setting that he/she set even after the factory reset has been executed. This improves the new user's convenience.

### Effects of Present Embodiment

In the case where the MFP 10 determines that its installation environment has changed based on the network address of the network to which the MFP 10 belongs (YES in S12 of FIG. 2), the MFP 10 sends change information to the server 50 (S16). In the case where the factory reset request is provided from the terminal 200 (i.e., terminal of the administrator of the MFP 10) to the server 50, the MFP 10 receives a factory reset instruction from the server 50 (YES in S18) and executes the factory reset to delete at least one setting information from the memory 34 (S22 and S24). As described, this embodiment including Cases A to C provides the novel technology for deleting setting information in the MFP 10.

### Correspondence Relationships

The MFP 10 is an example of “function executing device”. The network addresses are examples of “environmental information”. The factory reset request and the factory reset instruction are examples of “deletion request” and “deletion instruction”, respectively. The unconnectable flag is an example of “specific information”. The device name “DV1” and the device name “DV2” are examples of “first identification information” and “second identification information”, respectively. The factory reset flag is an example of “flag”. The factory reset flag “OFF” and the factory reset flag “ON” are examples of “first value” and “second value”, respectively.

Correspondence relationships regarding the function executing device are as follows. For example, S12 in FIG. 2 is an example of “determine whether the installation environment of the function executing device has changed”. For example, S16 in FIG. 2 is an example of “send change information”. For example, S18 in FIG. 3 is an example of “receive a deletion instruction”. For example, S22, S24 in FIG. 2 are examples of “delete at least one setting information”. S32 in FIG. 2 is an example of “store specific information”. T118 in FIG. 5 is an example of “store item information”.

Correspondence relationships regarding the server are as follows. For example, T38 in FIGS. 3, T70 and T92 in FIG. 4 are examples of “receive change information”. For example, T42 and T96 in FIG. 3 are examples of “send a deletion instruction”. For example, T22 and T48 in FIG. 3 are examples of “store first identification information for identifying the function executing device and a flag”. For example, T22 in FIG. 3 is an example of “change the flag”. For example, T48 in FIG. 3 is an example of “store second identification information for identifying the function executing device and the flag”.

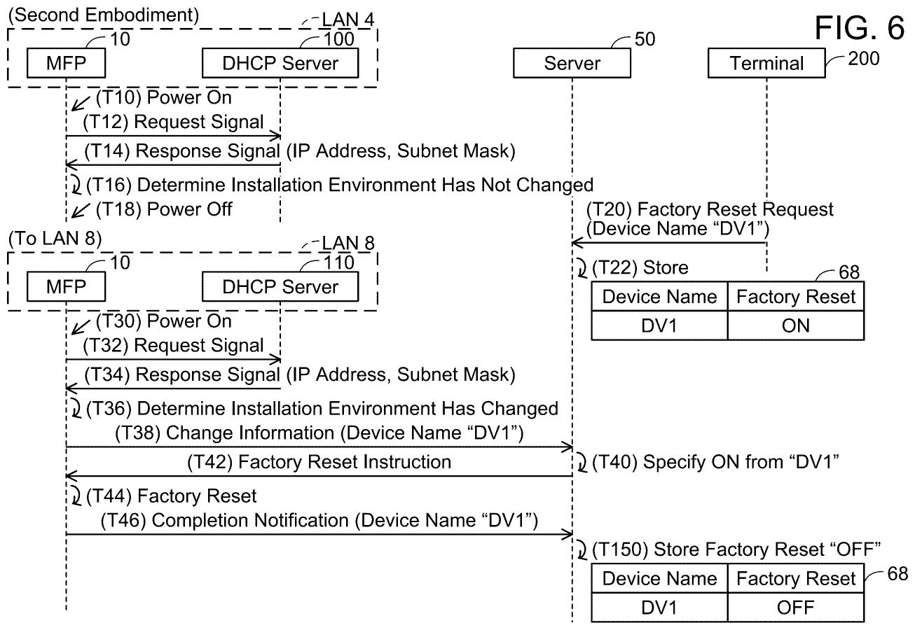

### Second Embodiment: FIG. 6

A second embodiment is described. This embodiment differs from the first embodiment in the process by the server 50. In FIG. 6, actions same as those shown in FIG. 3 are labeled with the same signs and description for them is omitted.

In response to receiving a completion notification including the device name “DV1” from the MFP 10 in T46, the server 50 changes the factory reset flag associated with the device name “DV1” included in the received completion notification from “ON” to “OFF” in T150. Thus, the completion notification can be understood as a notification for changing the factory reset flag from “ON” to “OFF”. In this embodiment, the server 50 does not create a new device name (i.e., “DV2” in the first embodiment). Therefore, the device name “DV1” remains stored in the MFP 10 even after the MFP 10 has been given to the new user.

Thereafter, for example, it can be contemplated that the MFP 10 is connected to a network different from the LAN 8 without the MFP 10 being given from the new user to another user, and the MFP 10 sends change information including the device name “DV1” to the server 50. Since the factory reset flag “OFF” is associated with the device name “DV1” in the device table 68 in the server 50 (T150), the server 50 does not send a factory reset instruction to the MFP 10. Therefore, the factory reset is not executed in the MFP 10. Thus, when the installation environment of the MFP 10 changes without the user (owner) of the MFP 10 being changed, the factory reset by the MFP 10 can be prevented. In this embodiment, T46 in FIG. 6 is an example of “send a completion notification”.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below.

(Modification 1) “Environmental information” may not be a network address, and may be for example the IP address of the MFP 10. This is useful in a configuration in which an IP address of a device remain unchanged even when the network to which the device belongs changes. “Environmental information” may be IP addresses of the other devices that belong to the network to which the MFP 10 belongs. This is useful in a configuration in which the IP addresses of the other devices remain unchanged. “Environmental information” may be MAC addresses of the other devices that belong to the network to which the MFP 10 belongs. “Environmental information” may be a gateway IP address, an address of an authentication server, or the like. “Environmental information” may be GPS location information of the MFP 10. That is, “environmental information” may be any information as long as whether the installation environment information of the function executing device has changed or not can be determined based on it.

(Modification 2) S20, S22, and S32 in FIG. 2 may be omitted. In this case, the MFP 10 does not store non-deletion setting information. In this modification, “store specific information” and “store item information” may be omitted.

(Modification 3) The MFP 10 may create the device names “DV1”, “DV2” of the MFP 10. In this case, the for example in T46 of FIG. 3, the MFP 10 sends the created device name “DV2” together with the completion notification. The server 50 then stores the received device name “DV2” and the factory reset flag “OFF” in the device table 68 in T48. In this case, T50 and T52 are not executed.

(Modification 4) In the embodiments above, the processes shown in FIGS. 2 to 6 are implemented by software (e.g., the program 36 of the MFP 10, the program 66 of the server 50), however, at least one of the processes may be implemented by hardware such as a logic circuit, etc.

What is claimed is:

1. A function executing device, comprising:
a memory configured to store a plurality of setting information corresponding to a plurality of setting items; and
a controller,
wherein the controller is configured to:
acquire environmental information related to an installation environment of the function executing device;
determine whether the installation environment of the function executing device has changed by using the environmental information;
in a case where it is determined that the installation environment of the function executing device has changed, send change information to a server;
in a case where the change information is sent to the server and a deletion request is provided to the server from a user of the function executing device, receive a deletion instruction from the server; and
in a case where the deletion instruction is received from the server, delete at least one setting information of the plurality of setting information from the memory.

2. The function executing device as in claim 1, wherein
in a case where setting information corresponding to a specific setting item of the plurality of setting items is changed by the user within a time period from when it is determined that the installation environment of the function executing device has changed to when the deletion instruction is received from the server, the controller is configured to delete the at least one setting information without deleting the changed setting information corresponding to the specific setting item from the memory.

3. The function executing device as in claim 1, wherein
the controller is further configured to:
in the case where it is determined that the installation environment of the function executing device has changed, store specific information in the memory; and
in a case where the setting information corresponding to the specific setting item is changed by the user under a state where the specific information is in the memory, store item information indicating the specific setting item in the memory,
wherein in the case where the deletion instruction is received from the server, the controller is configured to delete the at least one setting information without deleting the changed setting information corresponding to the specific setting item indicated by the item information from the memory.

4. The function executing device as in claim 1, wherein
the server is configured to:
store first identification information for identifying the function executing device and a flag in association with each other;
in a case where the deletion request is acquired from the user, change the flag from a first value to a second value;
in a case where the change information including the first identification information is received from the function executing device under a state where the flag indicates the second value, send the deletion instruction to the function executing device, wherein in a case where the change information including the first identification information is received from the function executing device under a state where the flag indicates the first value, the deletion instruction is not sent to the function executing device; and
store second identification information for identifying the function executing device and the flag indicating the first value in association with each other after the deletion instruction has been sent to the function executing device, the second identification information being different from the first identification information,
the memory is configured to:
store the first identification information before the deletion instruction is received from the server; and
store the second identification information as a replacement for the first identification information after the deletion instruction has been received from the server, and
the controller is configured to:
in a case where it is determined that the installation environment of the function executing device has changed under a state where the first identification information is in the memory, send the change information including the first identification information to the server; and
in a case where it is determined that the installation environment of the function executing device has changed under a state where the second identification information is in the memory, send the change information including the second identification information to the server.

5. The function executing device as in claim 4, wherein
the memory is configured to:
store the first identification information received from the server before the deletion instruction is received from the server; and
store the second identification information received from the server after the deletion instruction has been received from the server.

6. The function executing device as in claim 1, wherein
the server is configured to:
store first identification information for identifying the function executing device and a flag in association with each other;
in a case where the deletion request is acquired from the user, change the flag from a first value to a second value; and
in a case where the change information including the first identification information is received from the function executing device under a state where the flag indicates the second value, send the deletion instruction to the function executing device, wherein in a case where the change information including the first identification information is received from the function executing device under a state where the flag indicates the first value, the deletion instruction is not sent to the function executing device, and
the controller is further configured to:
in the case where the deletion instruction is received from the server, send a completion notification including the first identification information to the sever, wherein the completion notification is an instruction to change the flag associated with the first identification information from the second value to the first value.

7. The function executing device as in claim 1, wherein the environmental information is a network address.

8. A server comprising:
a controller,
wherein the controller is configured to:
in a case where an installation environment of a function executing device changes, receive change information from the function executing device, wherein the function executing device is configured to store a plurality of setting information corresponding to a plurality of setting items; and
in a case where the change information is received from the function executing device and a deletion request is acquired from a user of the function executing device, send a deletion instruction to the function executing device, wherein the deletion instruction is an instruction to delete at least one setting information of the plurality of setting information.

9. The server as in claim 8, further comprising a memory, wherein
the controller is further configured to:
store first identification information for identifying the function executing device and a flag in association with each other in the memory; and
in a case where the deletion request is acquired from the user, change the flag from a first value to a second value,
wherein in a case where the change information including the first identification information is received from the function executing device under a state where the flag indicates the second value, the controller is configured to send the deletion instruction to the function executing device, wherein in a case where the change information including the first identification information is received from the function executing device under a state where the flag indicates the first value, the deletion instruction is not sent to the function executing device.

10. The server as in claim 9, wherein
the controller is further configured to:
store second identification information for identifying the function executing device and the flag indicating the first value in association with each other in the memory after the deletion instruction has been sent to the function executing device, the second identification information being different from the first identification information.

11. The server as in claim 8, wherein
in a case where the change information is received from the function executing device after the deletion request has been acquired from the user, the controller is configured to send the deletion instruction to the function executing device in response to the receipt of the change information.

12. The server as in claim 8, wherein
in a case where the change information is received from the function executing device before the deletion request is acquired from the user, the controller does not send the deletion instruction to the function executing device until the deletion request is acquired.

13. A non-transitory computer-readable storage medium storing computer-readable instructions for a function executing device, wherein
the function executing device comprises:
a processor; and
a memory configured to store a plurality of setting information corresponding to a plurality of setting items,
the computer-readable instructions, when executed by the processor, cause the function executing device to:
acquire environmental information related to an installation environment of the function executing device;
determine whether the installation environment of the function executing device has changed by using the environmental information;
in a case where it is determined that the installation environment of the function executing device has changed, send change information to a server;
in a case where the change information is sent to the server and a deletion request is provided to the server from a user of the function executing device, receive a deletion instruction from the server; and
in a case where the deletion instruction is received from the server, delete at least one setting information of the plurality of setting information from the memory.
